(19) United States
(12) Patent Application Publication
(10) Pub. No.: US 2026/0094021 A1
(43) Pub. Date: Apr. 2, 2026

(54) MANAGING INFERENCE MODEL TRAINING ON AN EXPANDED KNOWLEDGE BASE

(71) Applicant: Dell Products L.P., Round Rock, TX (US)

(72) Inventors: OFIR EZRIELEV, Be'er Sheva (IL); JEHUDA SHEMER, Kfar Saba (IL); ONUR CELEBIOGLU, Austin, TX (US)

(21) Appl. No.: 18/899,044

(22) Filed: Sep. 27, 2024

(51) Int. Cl. G06N 5/04; G06N 5/022

(52) U.S. Cl. CPC G06N 5/04; G06N 5/022

(57) ABSTRACT

Methods and systems for providing computer-implemented services using inference models are disclosed. To provide the computer-implemented services, supplemental training data may be obtained, the supplemental training data being usable to train a prototype inference model and the prototype inference model being based on an existing inference model. Performance of a training procedure may be initiated using at least the supplemental training data and a set of prompts based on the supplemental training data until performance criteria are met. If the performance criteria are met, the prototype inference model may be promoted to a production ready inference model and used to provide the computer-implemented services.

### FIELD

Embodiments disclosed herein relate generally to managing inference models. More particularly, embodiments disclosed herein relate to systems and methods to manage inference model training on an expanded knowledge base.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2F show diagrams illustrating data flows in accordance with an embodiment.

FIGS. 3A-3D show flow diagrams illustrating a method for providing computer-implemented services using inference models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using inference models. An inference model may be a generative artificial intelligence (AI) model (e.g., a large language model (LLM)) and may generate responses when provided with prompts. The responses may be used, at least in part, to provide the computer-implemented services. However, a quality of the computer-implemented services may be impacted by the knowledge base of the inference model.

For example, an existing inference model which was trained using a base set of training data to have a knowledge base may be used to provide computer-implemented services. Over time, to improve a quality of the computer-implemented services provided using the existing inference model, the existing inference model may be updated to obtain a production ready inference model with an expanded knowledge base when compared to the knowledge base of the existing inference model. The production ready inference model may be intended to replace the existing inference model in the provision of the computer-implemented services. The expanded knowledge base may improve an ability of the production ready inference model to meet needs of a downstream consumer of the computer-implemented services.

To obtain the production ready inference model that has the expanded knowledge base, training, optimization, and/or evaluation processes may be performed. During the training, optimization, and/or evaluation processes, a prototype inference model may undergo training using supplemental training data followed by optimization and evaluation processes until an entity responsible for determining whether the prototype inference model has the expanded knowledge base (e.g., a subject matter expert (SME)) deems the prototype inference model production ready.

However, the training, optimization, and/or evaluation processes used to obtain the production ready inference model that has the expanded knowledge base may be repeated any number of times and with any quantity of supplemental training data until the SME (and/or another entity) determines whether the prototype inference model is approved for use in providing the computer-implemented services (e.g., production ready). Doing so may consume an undesirable quantity of resources (e.g., computational resources, time resources, cognitive resources of the SME). In addition, the production ready inference model may continue to be updated over time (e.g., may be replaced with a second production ready inference model, may be at least partially modified). To update the production ready inference model, the training, optimization, and/or evaluation processes may be repeated, thereby consuming additional resources that may otherwise be allocated to providing the computer-implemented services. Consequently, the computer-implemented services may be delayed, interrupted, and/or may otherwise be negatively impacted.

To reduce resource expenditure during obtaining a production ready inference model, evaluation of a knowledge base of a prototype inference model may be performed during training. The evaluation may include using a second inference model (e.g., an existing inference model) to evaluate a consistency and accuracy of responses obtained from the prototype inference model in response to a set of prompts based on supplemental training data. To do so, a training procedure may be initiated for the prototype inference model.

During the training procedure, a set of prompts may be obtained (e.g., from a SME, from a third inference model) based on the supplemental training data. Each prompt of the set of prompts may be intended to elicit a response with a same information content from the supplemental training data and may have a different phrasing from phrasings of other prompts of the set of prompts. The set of prompts may be used to evaluate a consistency and/or accuracy of the prototype inference model until performance criteria are met. The performance criteria may be usable to identify when the training procedure is complete and may define a level of ability of the prototype inference model to utilize the expanded knowledge base to generate desirable responses to the set of prompts. Once the performance criteria are met, the prototype inference model may be promoted to the production ready inference model, and used to provide the computer-implemented services.

To initiate the training procedure, a first partial training procedure for the inference model may be performed. A first testing procedure may then be performed to determine whether the prototype inference model provides consistent and accurate responses to the set of prompts. If the prototype inference model provides the consistent and accurate responses, it may be concluded that the prototype inference model meets the performance criteria. Meeting the performance criteria may indicate that the prototype inference model is sufficiently able to utilize the expanded knowledge base as desired by consumers of the computer-implemented services. If the prototype inference model does not provide the consistent and accurate responses, it may be concluded that the prototype inference model does not meet performance criteria, and a second partial retaining procedure for the prototype inference model may be performed. The prototype inference model may continue to undergo iterative cycles of training and testing until the performance criteria are met.

Thus, embodiments disclosed herein may address, among other technical problems, the technical challenge of evaluating when a prototype inference model has been sufficiently trained on an expanded knowledge base using an existing inference model. If the prototype inference model has the expanded knowledge base, the prototype inference model may be promoted to a production ready inference model and used to provide computer-implemented services. By evaluating the knowledge base of the prototype inference model during training, a resource expenditure during training and/or evaluation may be reduced (e.g., by not consuming additional resources to train the prototype inference model after the prototype inference model is sufficiently trained on the expanded knowledge base). Consequently, a likelihood of providing computer-implemented services to downstream consumers as desired may be increased.

In an embodiment, a method for providing computer-implemented services using inference models is disclosed. The method may include: obtaining supplemental training data, the supplemental training data being usable to train a prototype inference model of the inference models, and the prototype inference model being based on an existing inference model of the inference models; initiating performance of a training procedure for the prototype inference model using at least the supplemental training data and a set of prompts based on the supplemental training data unit performance criteria are met, the performance criteria being usable to identify when the training procedure is complete and the performance criteria defining a level of ability of the prototype inference model to utilize an expanded knowledge base from the supplemental training data to generate desirable responses to the set of prompts; in a first instance of the initiating in which the performance criteria are met: promoting the prototype inference model to a production ready inference model; and using the production ready inference model to provide the computer-implemented services.

Initiating performance of the training procedure may include: performing, using the supplemental training data, a first partial training procedure for the prototype inference model; performing a first testing procedure to determine whether the prototype inference model provides consistent and accurate responses to the set of prompts; in a first instance of the performing in which the prototype inference model provides the consistent and accurate responses: concluding that the prototype inference model meets the performance criteria; and in a second instance of the performing in which the prototype inference model does not provide the consistent and accurate responses: performing a second partial training procedure for the prototype inference model.

Performing the first testing procedure may include: performing a first attempting to verify that the prototype inference model provides the consistent responses to the set of prompts; in a first instance of the first attempting where the prototype inference model provides the consistent responses: performing a second attempting to verify that the existing inference model provides inconsistent responses to the set of prompts; in a first instance of the second attempting where the existing inference model provides the inconsistent responses: performing, using the set of prompts, a third attempting to verify that the prototype inference model provides the accurate responses.

Performing the first attempting may include: obtaining, using the set of prompts, a set of responses from the prototype inference model, the set of responses including: a first response to a first prompt of the set of prompts; and a second response to a second prompt of the set of prompts; performing a response agreement testing process to obtain a level of agreement between at least the first response and the second response; making a determination regarding whether the level of agreement meets the criteria; in a first instance of the determination in which the level of agreement meets the criteria: concluding that the prototype inference model provides the consistent responses to the set of prompts; and in a second instance of the determination in which the level of agreement does not meet the criteria: concluding that the prototype inference model does not provide the consistent responses to the set of prompts.

Performing the third attempting may include: comparing a first information content of the consistent responses to a second information content of the supplemental training data to obtain a level of similarity between the first information content and the second information content; making a second determination regarding whether the level of similarity meets a level of similarity threshold; in a first instance of the second determination in which the level of similarity meets the level of similarity threshold: concluding that the prototype inference model provides the accurate responses; and in a second instance of the second determination in which the level of similarity does not meet the level of similarity threshold: concluding that the prototype inference model does not provide the accurate responses.

The prototype inference model may be intended to have the expanded knowledge base when compared to a knowledge base of the existing inference model.

Providing consistent and accurate responses to the set of prompts may indicate that the prototype inference model has the expanded knowledge base.

The set of prompts may be adapted to elicit responses from inference models including information content from the supplemental training data.

The existing inference model may be based on a base set of training data that excludes the supplemental training data, and the information content from the supplemental training data may not be part of the base set of training data.

The prototype inference model and the existing inference model may be known to provide consistent responses to a second set of prompts, the second set of prompts being based on a knowledge base of the existing inference model.

The existing inference model and the prototype inference model may be generative artificial intelligence (AI) models.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

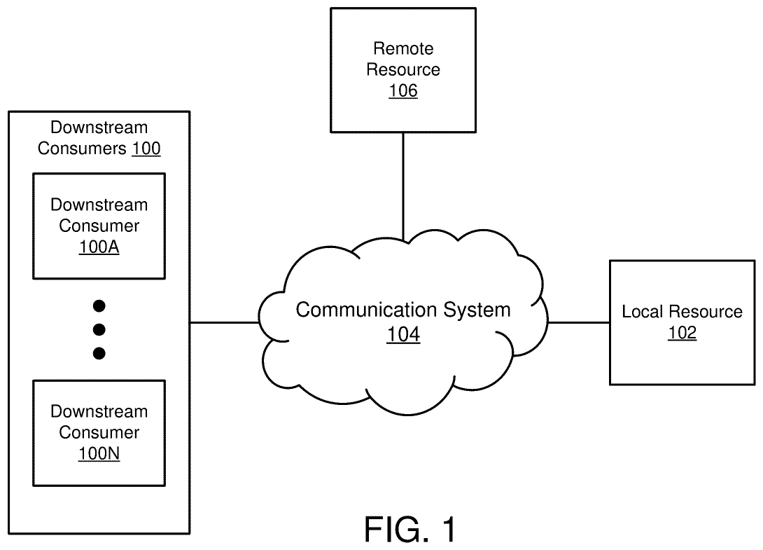

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided, at least in part, using inference models and/or inferences (e.g., responses) obtained using the inference models.

To provide the computer-implemented services, the inference models may be trained, operated, and/or otherwise controlled (e.g., hosted) by a remote resource (e.g., a third-party entity), and/or by an entity that obtains the responses used to provide the computer-implemented services (e.g., a local resource). The local resource may be owned by a first owner and the remote resource may be owned by a second owner. In addition, the first owner may not control the remote resource. For example, an inference model used in the provision of the computer-implemented services may be hosted by the remote resource and may provide responses to the local resource, and/or the inference model may be hosted by the local resource and may provide responses to the local resource. The responses may be provided to downstream consumers as computer-implemented services and/or may be utilized to facilitate the computer-implemented services.

To obtain the responses used to provide the computer-implemented services, the inference models may be trained, using training data, to generate the responses when provided with prompts (e.g., ingest data). The inference models may include generative artificial intelligence (AI) inference models (e.g., large language models (LLMs)); therefore, the responses may include new instances of data created by the generative AI inference models based on learned associations from and/or an understanding of the training data. For example, the inference models may be trained using unstructured data, such as stories, essays, audio transcription, video description, and/or other types of human interpretable text, to generate responses of the same.

For example, an existing inference model may be trained using a base set of training data to have a knowledge base. The existing inference model may obtain prompts based on the base set of training data and generate responses used to provide the computer-implemented services using the knowledge base. Over time, in order to improve a quality of the computer-implemented services provided using the responses, the existing inference model may be updated (e.g., retrained) using supplemental training data to obtain a production ready inference model with an expanded knowledge base when compared to a knowledge base of the existing inference model. In doing so, the production ready inference model may obtain prompts based on the base set of training data and/or the supplemental training data and generate responses using the expanded knowledge base. The expanded knowledge base may improve an ability of the production ready inference model to meet needs of a downstream consumer of the computer-implemented services.

In order to obtain the production ready inference model that has the expanded knowledge base, training, optimization, and/or evaluation processes may be performed (e.g., by the local resource, by the first owner, by another entity trusted by the first owner). During the training, optimization, and/or evaluation processes, a prototype inference model may undergo training using the supplemental training data followed by optimization and evaluation processes until an entity responsible for determining whether the prototype inference model has the expanded knowledge base (e.g., a subject matter expert (SME)) deems the prototype inference model production ready.

However, the training, optimization, and/or evaluation processes used to obtain the production ready inference model that has the expanded knowledge base may be repeated any number of times and with any quantity of supplemental training data until the SME (and/or another entity) determines whether the prototype inference model is approved for use in providing the computer-implemented services (e.g., production ready). For example, the prototype inference model may undergo any number of global optimization cycles (e.g., using methods such as gradient descent) until the SME deems the prototype inference model production ready. Doing so may consume an undesirable quantity of resources (e.g., computational resources, time resources, cognitive resources of the SME). In addition, the production ready inference model may continue to be updated over time (e.g., may be replaced with a second production ready inference model, may be at least partially modified). To update the production ready inference model, the training, optimization, and/or evaluation processes may be repeated, thereby consuming additional resources that may otherwise be allocated to providing the computer-implemented services. Consequently, the computer-implemented services may be delayed, interrupted, and/or may otherwise be negatively impacted.

In general, embodiments disclosed herein may provide methods, systems, and/or devices for determining when an inference model has been sufficiently trained on an expanded knowledge base using a second inference model. By using the second inference model to determine when to stop training the inference model, a likelihood of providing computer-implemented services in a desired manner may be increased while conserving resources consumed during training, optimization, and/or evaluation processes of the inference model.

To do so, a production ready inference model may be obtained based on an existing inference model and supplemental training data. The production ready inference model and the existing inference model may be generative AI models (e.g., large language models (LLMs)). The existing inference model may have a knowledge base based on a base set of training data (e.g., which does not include the supplemental training data). The production ready inference model may be intended to have an expanded knowledge base when compared to the knowledge base of the existing inference model (e.g., may be intended to have knowledge of a first information content of the supplemental training data in addition to knowledge of a second information content of the base set of training data), which may improve a quality, type, and/or other characteristic of the computer-implemented services provided using the production ready inference model.

To obtain the production ready inference model used in the provision of the computer-implemented services, a training procedure may be initiated for a prototype inference model. To perform the training procedure, a set of prompts may be obtained (e.g., from a SME, from a third inference model) based on the supplemental training data. Each prompt of the set of prompts may be intended to elicit a response with a same information content from the supplemental training data and may have a different phrasing from phrasings of other prompts of the set of prompts. The set of prompts may be used to evaluate a consistency and/or accuracy of responses generated by the prototype inference model until performance criteria are met. The performance criteria may be usable to identify when the training procedure is complete and may define a level of ability of the prototype inference model to utilize the expanded knowledge base to generate desirable (e.g., consistent and/or accurate) responses to the set of prompts. Once the performance criteria are met, the prototype inference model may be promoted to the production ready inference model, and used to provide the computer-implemented services.

To initiate the training procedure, a first partial training procedure for the inference model may be performed. A first testing procedure may then be performed to determine whether the prototype inference model provides consistent and accurate responses to the set of prompts. If the prototype inference model provides the consistent and accurate responses, it may be concluded that the prototype inference model meets the performance criteria, which may indicate that the prototype inference model has the expanded knowledge base as desired. If the prototype inference model does not provide the consistent and accurate responses, it may be concluded that the prototype inference model does not meet performance criteria, and a second partial retaining procedure for the prototype inference model may be performed. The prototype inference model may continue to undergo iterative cycles of training and testing until the performance criteria are met.

By doing so, embodiments disclosed herein may improve processes of evaluating knowledge bases of inference models so that responses generated by the inference models may have an increased likelihood of being trustworthy for use in providing computer-implemented services to downstream consumers. By evaluating the knowledge base of a prototype inference model during training, a resource expenditure during training and/or evaluation may be reduced by not continuing to train the prototype inference model after the prototype inference model is sufficiently trained on an expanded knowledge base to provide responses as desired by a consumer of the computer-implemented services.

To provide the above noted functionality, the system of FIG. 1 may include downstream consumers 100, local resource 102, remote resource 106, and communication system 104. Each of these components is discussed below.

Downstream consumers 100 may provide and/or consume all, or a portion of, the computer-implemented services. Downstream consumers 100 may include any number of downstream consumers (e.g., 100A, 100N) and may include, for example, businesses, individuals, and/or devices (e.g., data processing systems) that may obtain responses and/or other information based on the responses as part of receiving the computer-implemented services.

Downstream consumers 100 may subscribe to computer-implemented services provided, at least in part, by local resource 102 and local resource 102 may interact with any number of other entities (e.g., remote resource 106) as part of providing the computer-implemented services. For example, remote resource 106 may provide inferencing services to local resource 102 and local resource 102 may use inferences (e.g., responses) generated by inference models hosted by remote resource 106 as part of the computer-implemented services provided to downstream consumers 100. Local resource 102 may also host inference models locally which may provide the responses used by local resource 102 in the provision of the computer-implemented services.

Remote resource 106 may manage any number of inference models and may be owned by a second owner (e.g., a third-party entity). For example, remote resource 106 may train, and/or host (e.g., operate) generative AI models and may provide inferencing services to any number of other entities. However, the inference models (e.g., the generative AI models) may be updated (e.g., retrained) over time to improve a quality of the computer-implemented services (e.g., by remote resource 106, by local resource 102). To do so, training and/or evaluation processes for the inference models may be performed prior to providing computer-implemented services based on responses received from the inference models.

Local resource 102 may include any entity that provides, at least in part, computer-implemented services to downstream consumers 100. Local resource 102 may be owned by a first owner and the first owner may not control remote resource 106, and/or local resource 102 and remote resource 106 may be controlled by a single entity. To provide its functionality, local resource 102 may: (i) train (e.g., using a base set of training data, using supplemental training data, using other training data) and/or host any number of inference models, (ii) perform consistency evaluations of inference models to determine whether the inference models provide consistent responses to a set of prompts, (iii) perform accuracy evaluations of inference models to determine whether the inference models provide accurate responses to the set of prompts (e.g., indicating the inference models have a desired knowledge base), and/or (iv) perform other actions.

For example, local resource 102 may perform consistency and/or accuracy evaluations during inference model training procedures to determine whether prototype inference models are to be promoted to production ready inference models (e.g., an inference model usable to provide the computer-implemented services as desired). The prototype inference models may include inference models which are based on existing inference models (e.g., the existing inference models may be updated, augmented, retrained, and/or otherwise modified to obtain the prototype inference models). The prototype inference models may also include inference models trained, at least in part, using a base set of training data used to train the existing inference models (e.g., the prototype inference models may have at least the knowledge base of the existing inference models). The prototype inference models may be intended to have an expanded knowledge base when compared to the knowledge base of the existing inference models (e.g., via training using supplemental training data in addition to the base set of training data). Upon completion of the training procedures, the prototype inference models may be promoted to production ready inference models, which may replace the existing inference models in the provision of the computer-implemented services. The inference models may include generative AI models such as LLMs.

Performing the training procedures may include performing partial training procedures. Performing partial training procedures may include: (i) obtaining training data (e.g., the base set of training data and the supplemental training data), (ii) using the training data to optimize the prototype inference models to identify parameters that most faithfully reproduce the trends in the training data, and/or (iii) other methods.

Following the partial training procedures, the prototype inference models may undergo consistency evaluations with respect to sets of prompts based on the supplemental training data. To perform the consistency evaluations of the prototype inference models, local resource 102 may: (i) obtain portions of the training data used to train the prototype inference models (e.g., the supplemental training data), (ii) obtain sets of prompts based on the supplemental training data, the sets of prompts being intended to elicit responses from the inference models that have a same information content from the supplemental training data, (iii) obtain, using the sets of prompts, sets of responses from the prototype inference models, (iv) perform, using another inference model (e.g., the existing inference model and/or a third inference model), response agreement testing processes to obtain levels of agreement between responses of the sets of responses, and/or (iv) compare the levels of agreement to criteria to determine whether the levels of agreement meet the criteria. Consistency evaluations of the existing inference models may also be performed to verify that the existing inference models provide inconsistent responses to the sets of prompts (e.g., the existing inference models do not have the expanded knowledge base). Consistency evaluations may also be performed using sets of prompts based on the base set of training data (e.g., of prototype inference models, of existing inference models) to evaluate inference model consistency with respect the base set of training data.

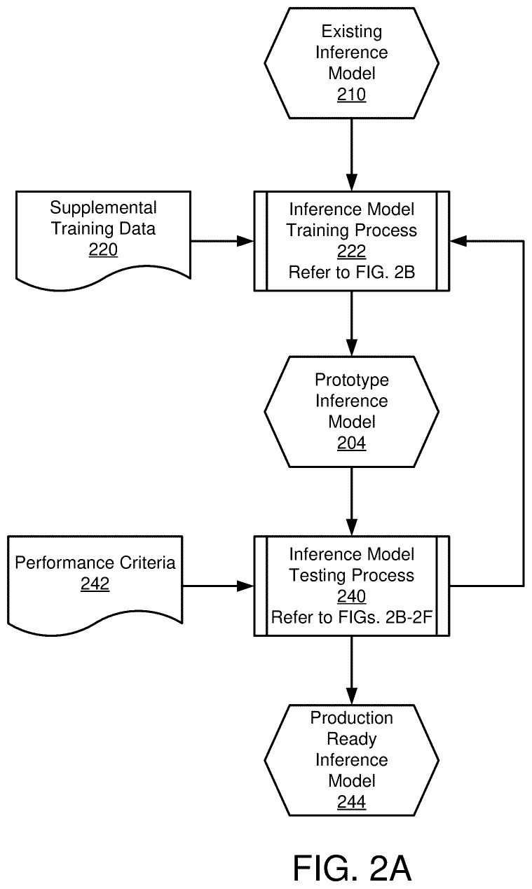

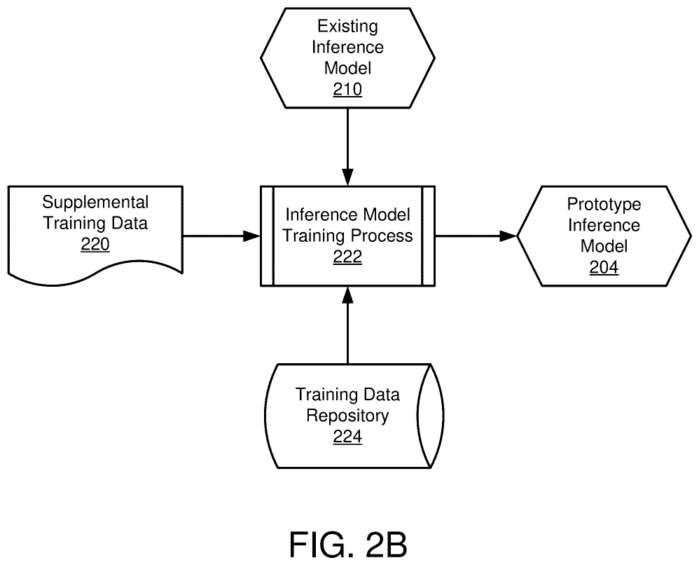

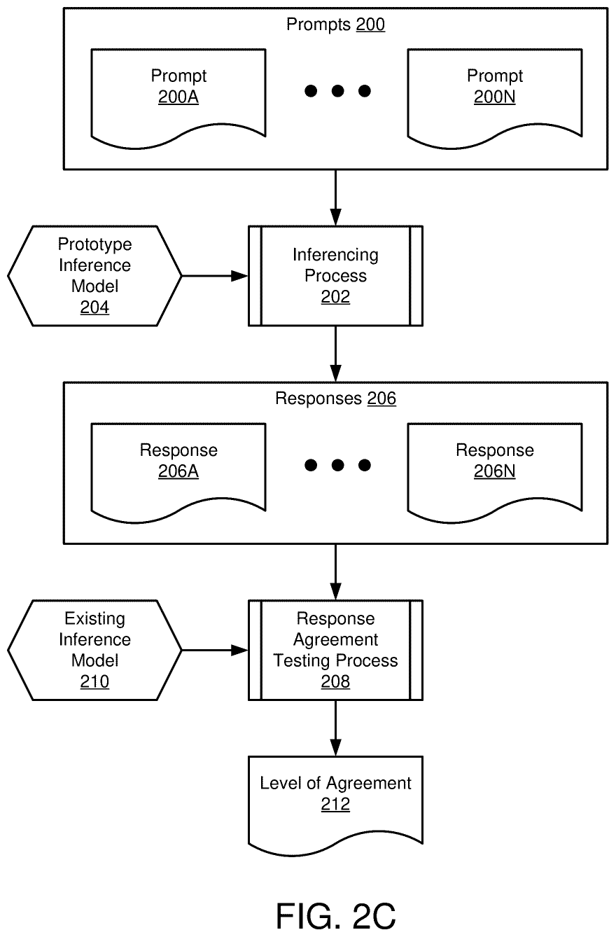

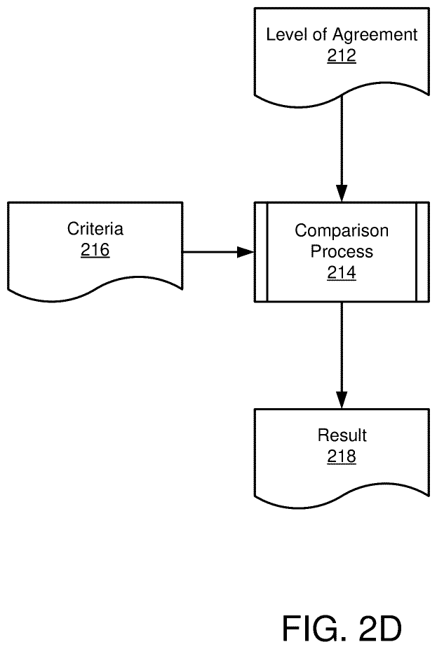

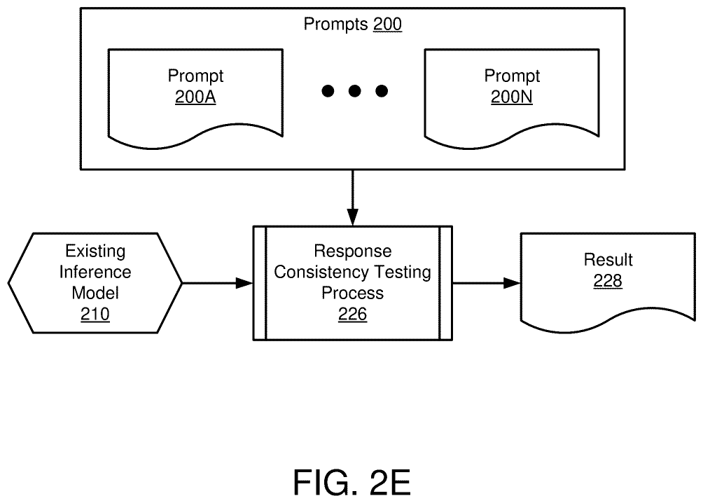

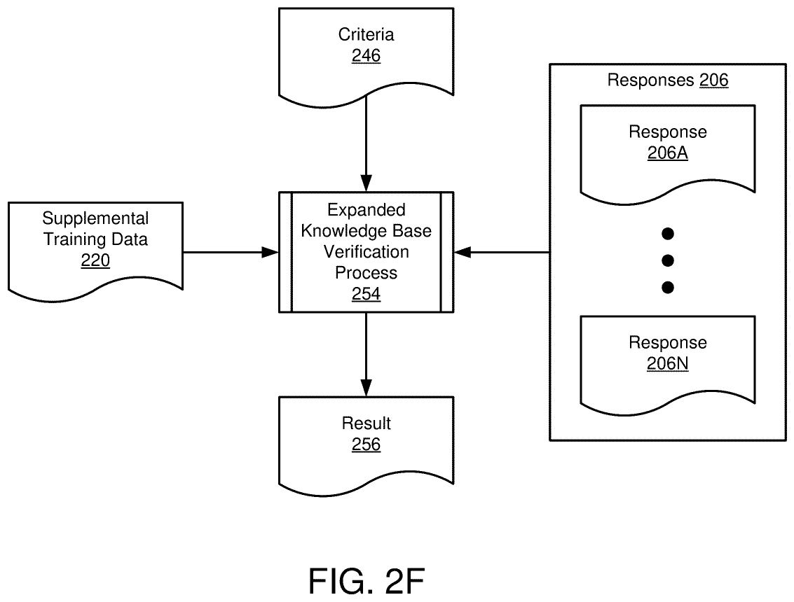

If the levels of agreement meet the criteria, local resource 102 may conclude that the inference model(s) provide consistent responses to the set of prompts. If the levels of agreement do not meet the criteria, local resource 102 may conclude that the inference model(s) do not provide consistent responses to the set of prompts (e.g., the inference model(s) provide inconsistent responses). Refer to FIGS. 2C-2D for additional details regarding evaluating whether inference models provide consistent responses to a set of prompts.

For example, a first consistency evaluation may be performed using a prototype inference model and an existing inference model and a first set of prompts based on a base set of training data (e.g., training data used to train, at least in part, both the prototype inference model and the existing inference model). It may be determined during the first consistency evaluation that both the prototype inference model and the existing inference model provide consistent responses to the first set of prompts. A second consistency evaluation may be performed using the prototype inference model and the existing inference model and a second set of prompts based on supplemental training data (e.g., training data used to train, at least in part, the prototype inference model). It may be determined during the second consistency evaluation that the prototype inference model provides consistent responses to the second set of prompts and the existing inference model provides inconsistent responses to the second set of prompts.

If the prototype inference model provides consistent responses to the set of prompts based on the supplement training data and the existing inference model provides inconsistent responses to the set of prompts based on the supplement training data, local resource 102 may perform an accuracy evaluation using the set of prompts based on the supplement training data. To do so, local resource 102 may: (i) obtain responses from the prototype inference model to the set of prompts based on the supplemental training data, (ii) compare a first information content of the responses to a second information content of the supplemental training data to obtain a level of similarity between the first information content and the second information content, and/or (iii) determine whether the level of similarity meets a level of similarity threshold.

If the level of similarity meets the level of similarity threshold, local resource 102 may: (i) conclude that the prototype inference model has the expanded knowledge base and/or (ii) provide computer-implemented services using at least the prototype inference model. If the level of similarity does not meet the level of similarity threshold, local resource 102 may perform a second partial training procedure for the prototype inference model. Refer to FIG. 2F for additional details regarding verifying that the prototype inference model has the expanded knowledge base.

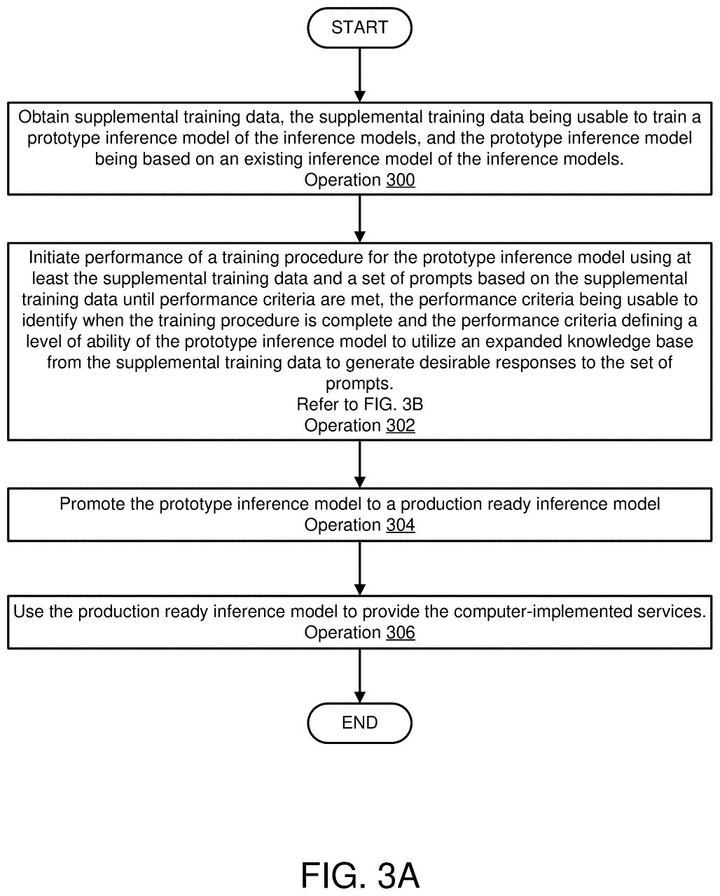

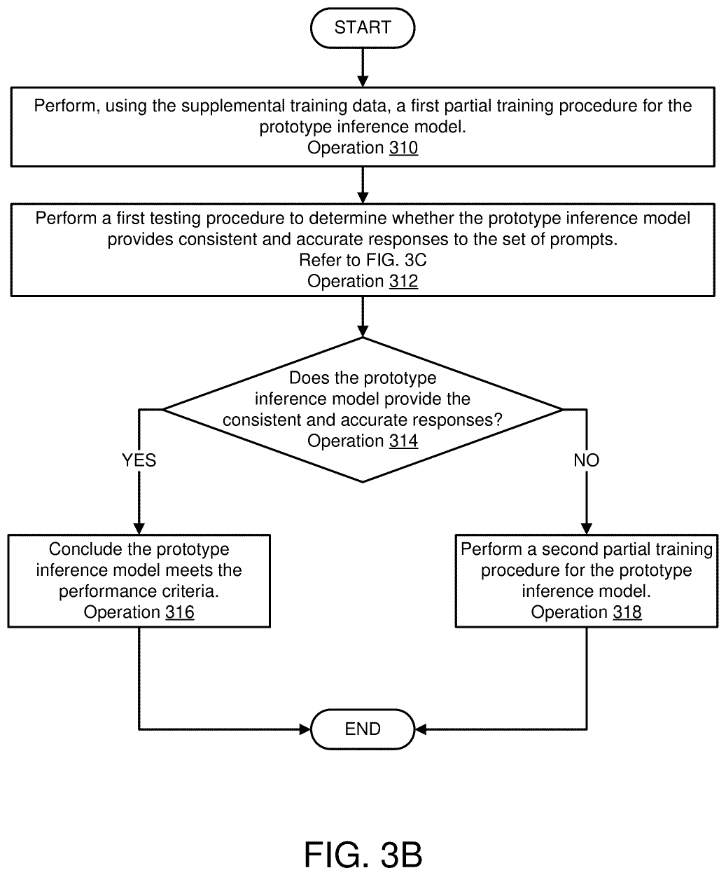

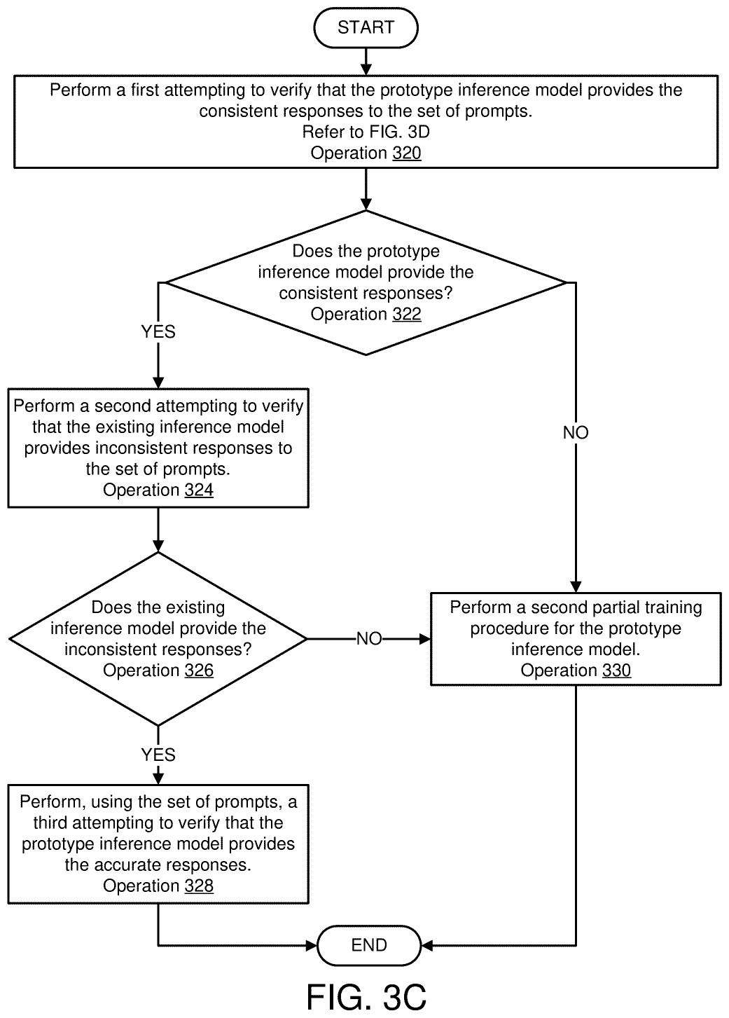

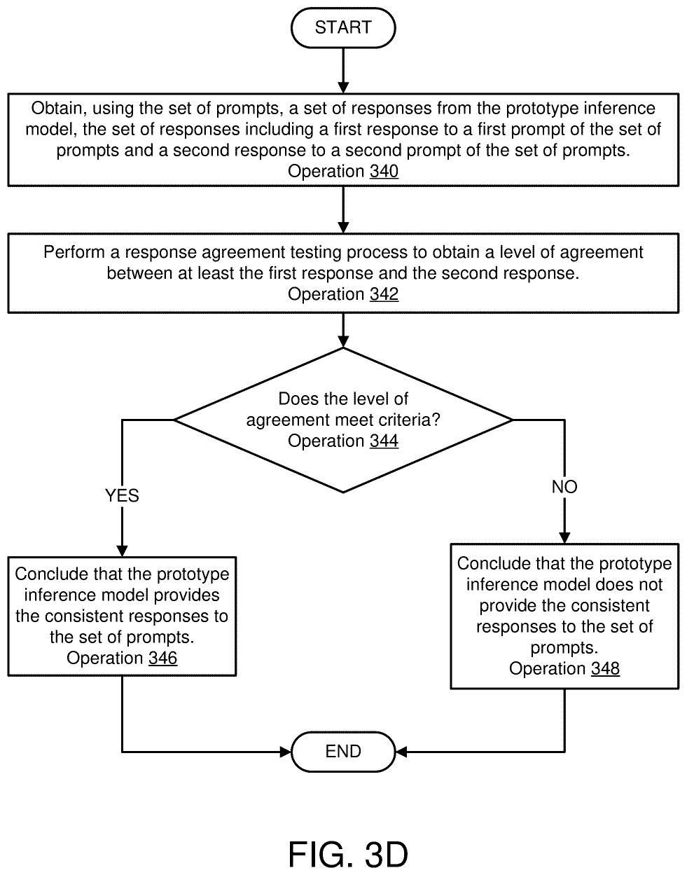

When providing their functionality, any of (and/or components thereof) downstream consumers 100, local resource 102, and/or remote resource 106 may perform all, or a portion, of the actions and methods illustrated in FIGS. 2A-3D.

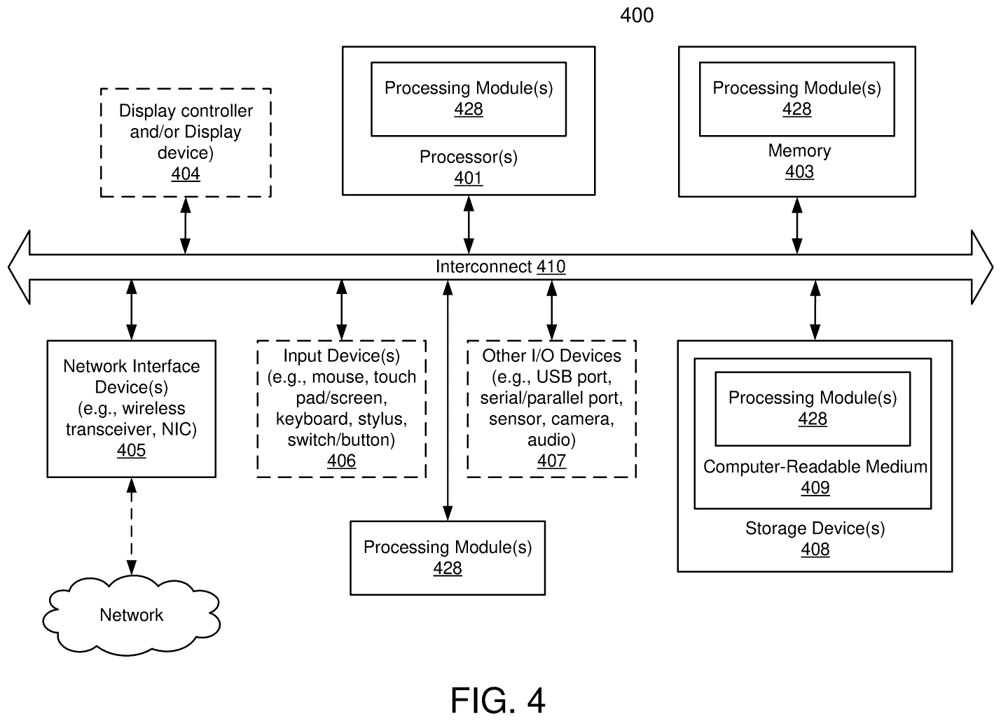

Any of (and/or components thereof) downstream consumers 100, local resource 102, and remote resource 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

The system described in FIG. 1 may be used to manage inference models to improve availability and/or quality of computer-implemented services provided to downstream consumers of the computer-implemented services. The following processes described in FIGS. 2A-2F may be performed by the system in FIG. 1 when providing this functionality.

To further clarify embodiments disclosed herein, data flow diagrams in accordance with an embodiment are shown in FIGS. 2A-2F. In these diagrams, flows of data and processing of data are illustrated using different sets of shapes. A first set of shapes (e.g., 242, 220, etc.) is used to represent data structures, a second set of shapes (e.g., 222, 240, etc.) is used to represent processes performed using and/or that generate data, a third set of shapes (e.g., 224) is used to represent large scale data structures such as databases, and a fourth set of shapes (e.g., 204, 210) is used to represent inference models.

Turning to FIG. 2A, a first data flow diagram in accordance with an embodiment is shown. The first data flow diagram may illustrate data used in and data processing performed in obtaining a production ready inference model (e.g., production ready inference model 244) based on an existing inference model (e.g., existing inference model 210).

To obtain production ready inference model 244, a training procedure may be initiated using at least supplemental training data 220 and a set of prompts based on the supplemental training data. Supplemental training data 220 may include any type and/or quantity of training data usable to train prototype inference model 204 to have an expanded knowledge base when compared to a knowledge base of existing inference model 210. Supplemental training data 220 may include data with an information content which is not included in a base set of training data used to obtain existing inference model 210. The training procedure may include inference model training process 222 and/or inference model testing process 240.

During inference model training process 222, prototype inference model 204 may be obtained using at least existing inference model 210 and supplemental training data 220. Prototype inference model 204 may be a generative AI model (e.g., an LLM) trained to generate language, understand language, and/or otherwise process requests related to languages. The generative AI model may include, for example, a neural network inference model. Prototype inference model 204 may be based on existing inference model 210 and may be intended to have an expanded knowledge base when compared to a knowledge base of existing inference model 210. During inference model training process 222, a first partial training procedure may be performed to obtain prototype inference model 204 using the supplemental training data. Refer to the description of FIG. 2B for additional details regarding inference model training process 222, prototype inference model 204 and existing inference model 210.

Upon obtaining prototype inference model 204, inference model testing process 240 may be performed as part of initiating the training procedure. Inference model testing process 240 may include performing a first testing procedure to determine whether prototype inference model 204 provides consistent and accurate responses to a set of prompts based on supplemental training data 220. Inference model testing process 240 may include comparing responses to the set of prompts obtained from prototype inference model 204 and/or second responses to the set of prompts obtained from existing inference model 210 to performance criteria 242.

Performance criteria 242 may be usable to identify when the training procedure is complete and may define a level of ability of prototype inference model 204 to utilize the expanded knowledge base from the supplemental training data to generate desirable responses to the set of prompts. Desirable responses may include responses which are both consistent and accurate with respect to the set of prompts. Prototype inference model 204 may meet performance criteria 242 when a consistency of the responses meets criteria 216 (not shown, refer to FIG. 2D), a consistency of the second responses does not meet criteria 216, and an accuracy of the first responses meets criteria 246 (not shown, refer to FIG. 2F).

If the responses obtained from prototype inference model 204 with respect to the set of prompts based on supplemental training data 220 are deemed consistent and accurate (e.g., meet performance criteria 242), it may indicate that prototype inference model 204 has the expanded knowledge base. As a result, prototype inference model 204 may be promoted to production ready inference model 244. Production ready inference model 244 may have a level of ability to utilize the expanded knowledge base which meets the needs of consumers of responses from production ready inference model 244. Thus, production ready inference model 244 may be used to provide the computer-implemented services.

If the responses obtained from prototype inference model 204 with respect to the set of prompts based on supplemental training data 220 are not deemed consistent and accurate (e.g., do not meet performance criteria 242), a second partial training procedure for prototype inference model 204 may be performed (e.g., at least a portion of inference model training process 222 may be repeated) to obtain an updated prototype inference model (not shown). Performing the second partial training process may include: (i) performing a second training cycle for prototype inference model 204 using additional supplemental training data, the additional supplemental training data being intended to train prototype inference model 204 to have the expanded knowledge base, (ii) repeating performance of optimization procedures and/or performing additional optimization procedures, and/or (iii) otherwise modifying and/or retraining prototype inference model 204 to improve a likelihood that prototype inference model 204 has the expanded knowledge base. A second inference model testing process 240 may then be performed for the updated prototype inference model using performance criteria 242. Cycles of training and testing prototype inference model 204 may continue until performance criteria 242 are met (and/or until a predetermined number of cycles are complete, at which point it may be determined that prototype inference model 204 is not usable to provide the computer-implemented services).

Turning to FIG. 2B, a second data flow diagram in accordance with an embodiment is shown. The second data flow diagram may illustrate data used in and data processing performed in obtaining a prototype inference model (e.g., prototype inference model 204) based on an existing inference model (e.g., existing inference model 210) and supplemental training data (e.g., supplemental training data 220).

Existing inference model 210 may be a generative AI model (e.g., an LLM) trained to generate language, understand language, and/or otherwise process requests related to languages. The generative AI model may include, for example, a neural network inference model. Existing inference model 210 may be trained using large training datasets to learn statistical relationships within text. Existing inference model 210 may be trained to generate inferences (e.g., responses, outputs) when provided with a prompt (e.g., ingest data). The inferences may include new instances of data created by existing inference model 210 based on learned associations from and/or an understanding of the training data. For example, existing inference model 210 may be trained using unstructured data, such as stories, essays, audio transcription, video description, and/or other types of human interpretable text, to generate inferences of the same.

Existing inference model 210 may be trained using a base set of training data and may therefore have a knowledge base based on the base set of training data. Following training, a consistency and/or accuracy evaluation may be performed to determine whether existing inference model 210 provides consistent and accurate responses (e.g., inferences) to a set of prompts based on the knowledge base (e.g., the set of prompts being intended to elicit responses including an information content of the base set of training data). The consistency and/or accuracy evaluation may be performed using any method. For example, a consistency evaluation of existing inference model 210 may be performed using methods similar to those described with respect to evaluating prototype inference model 204 in FIGS. 2C-2D. In addition, an accuracy evaluation of existing inference model 210 may be performed using methods similar to those described with respect to evaluating prototype inference model 204 in FIG. 2F. The consistency and/or accuracy of existing inference model 210 may be evaluated via any other methods without departing from embodiments disclosed herein.

While being used to provide computer-implemented services, existing inference model 210 may be augmented, updated, replaced, and/or otherwise modified to obtain prototype inference model 204. Existing inference model 210 may be modified to expand a knowledge base of existing inference model 210. For example, existing inference model 210 may be used in providing customer assistance services for an automobile manufacturer. Existing inference model 210 may provide the customer assistance services by obtaining prompts (e.g., questions) from customers regarding various automobiles sold by the manufacturer and providing information to the customers in response. The prompts may include questions regarding use of and/or features of specific models of the automobiles. In order to provide responses to the customers, existing inference model 210 may be updated to expand the knowledge base to include new information when the automobile manufacturer produces a new model of automobile.

To obtain prototype inference model 204, inference model training process 222 may be performed. During inference model training process 222, training data may be obtained and used to train and/or partially train prototype inference model 204. The training data may include any type and/or quantity of data, including a base set of training data (e.g., training data used to train existing inference model 210), data additional to that of the base set of training data (e.g., supplemental training data 220), and/or any other type of training data (e.g., additional supplemental training data). The base set of training data may exclude supplemental training data 220, and the information content from supplemental training data 220 may not be part of the base set of training data. The base set of training data may be obtained, for example, from training data repository 224. Training data repository 224 may include a database of training data usable to train inference models.

Continuing with the above example, prototype inference model 204 may be trained using a base set of training data used to train existing inference model 210, including data regarding previous models of automobiles sold by the automobile manufacturer. In addition to the base set of training data, prototype inference model 204 may also be trained using supplemental training data 220, which may include data regarding the new model of automobile.

Prototype inference model 204 may be trained using the training data which defines goals for output generated by prototype inference model 204 (e.g., responses). Parameters of prototype inference model 204 may be selected using an optimization process (e.g., an objective function may be defined in terms of the training data and responses generated by prototype inference model 204, and a global optimization method such as gradient descent may be used to identify parameters that most faithfully reproduce the trends in the training data). Once the parameters of prototype inference model 204 are set, then prototype inference model 204 may be used to generate responses based on input data (e.g., prompts).

Inference model training process 222 may also include obtaining prototype inference model 204 via modification of existing inference model 210. For example, existing inference model 210 may be a neural network inference model, which may include a series of layers of neurons. Prototype inference model 204 may be obtained using the architecture of the neural network of existing inference model 210, for example, by retraining and/or partially retraining the neurons and/or weights of the neural network based on supplemental training data 220.

By training prototype inference model 204, at least in part, on the base set of training data and/or by modifying existing inference model 210, prototype inference model 204 may have at least the knowledge base of existing inference model 210. As a result, prototype inference model 204 may provide consistent responses to the set of prompts based on the knowledge base of existing inference model 210. Returning to the automobile manufacturer example, prototype inference model 204 may have at least a knowledge base of the previous models of automobiles sold by the automobile manufacturer, and may therefore provide consistent responses to prompts regarding the previous models of automobiles.

After training and/or partially training prototype inference model 204 (e.g., after performance of a first partial training procedure), a first testing procedure may be performed to determine whether prototype inference model 204 provides consistent and accurate responses to a set of prompts based on supplemental training data 220. Refer to FIGS. 2C-2F for additional details regarding performing the first testing procedure.

Turning to FIG. 2C, a third data flow diagram in accordance with an embodiment is shown. The third data flow diagram may illustrate data used in and data processing performed in performing, at least in part, a first testing procedure for prototype inference model 204. The first testing procedure may include performing a first attempting to verify that prototype inference model 204 provides consistent responses to a set of prompts based on the supplemental training data (e.g., supplemental training data 220 shown in FIGS. 2A and 2B).

To perform the first attempting, inferencing process 202 may be performed using prompts 200. Prompts 200 may be obtained, for example, via: (i) generation by a SME, (ii) generation by a third inference model (not shown), and/or (iii) other methods. The third inference model (not shown) may also be a generative AI model (e.g., a third LLM).

Prompts 200 may be a set of prompts including any number of prompts (e.g., 200A-200N) that may be adapted to elicit responses from inference models including information content of the supplemental training data used to obtain prototype inference model 204. Prompt 200A, for example, may include human-interpretable text and may include a question to be answered by prototype inference model 204. Prompt 200A may: (i) include a solicitation for the same information content (e.g., as other prompts of prompts 200), and (ii) use a different phrasing from phrasings used by the other prompts of prompts 200.

Returning to the example discussed in FIG. 2B, prototype inference model 204 may be trained using a base set of training data including data regarding previous models of automobiles produced by an automobile manufacturing company, and supplemental training data including data regarding a new model of automobile. Prototype inference model 204 may be intended to have an expanded knowledge base (e.g., knowledge of the new model and the previous models) compared to a knowledge base of existing inference model 210 (e.g., knowledge of the previous models). Prompt 200A may include a solicitation (e.g., question) for prototype inference model 204 to provide a set of instructions for turning off an automatic emergency breaking feature using a first phrasing. Prompt 200B may include a second solicitation for prototype inference model 204 to provide the set of instructions for turning off the automatic emergency breaking feature (e.g., the same information content) using a second phrasing. The first phrasing may include human-interpretable text such as “how to turn off automatic emergency breaking feature” and the second phrasing may include human-interpretable text such as “disable automatic emergency breaking.” Other prompts of prompts 200 may include other phrasings such as “how to stop car from automatically emergency breaking,” etc. However, each prompt of prompts 200 may be intended to elicit the same information content that includes the set of instructions for turning off the automatic emergency breaking feature. The automatic emergency breaking feature may be a feature of the new model of automobile and may not be a feature of previous models. Thus, information regarding the automatic emergency breaking feature may be included in the supplemental training data and may not be included in the base set of training data.

While described with respect to prompts 200 including a set of prompts (e.g., 200A-200N) intended to elicit responses with a same information content, it may be appreciated that prompts 200 may include any number of additional sets of prompts (not shown) that may be intended to elicit other information content without departing from embodiments disclosed herein. For example, prompts 200 may include a second set of prompts (not shown) intended to elicit a second same information content different from the same information content.

During inferencing process 202, prompts 200 may be provided to prototype inference model 204. Prompts 200 may be obtained using a local resource, and prototype inference model 204 may be owned, hosted, and operated by the local resource and/or a remote resource. The local resource may be owned by a first owner and the remote resource may be owned by a second owner. The first owner may not control the remote resource (e.g., may not have knowledge of or an ability to modify operation of the remote resource). Therefore, if prototype inference model 204 is hosted by the remote resource, the local resource may not have knowledge of how prototype inference model 204 was trained, evaluated for consistency, evaluated for having a desired knowledge base, and/or other performance metrics.

During inferencing process 202, prompts 200 may be fed into prototype inference model 204 and responses 206 may be obtained from prototype inference model 204. Responses 206 may include any number of responses (e.g., 206A-206N). Each response of responses 206 may be responsive to a prompt of prompts 200. For example, response 206A may be responsive to prompt 200A. If prototype inference model 204 is hosted by the remote resource, responses 206 may be obtained from the remote resource (e.g., by the local resource, by the first owner) in response to prompts 200.

Responses 206 may include at least a first response (e.g., response 206A) with a first information content and a second response (e.g., response 206B) with a second information content. Continuing with the above example where prompts 200 may include requests for instructions to turn off an automatic emergency breaking feature, the first information content and the second information content may be intended to include the instructions for turning off the automatic emergency breaking feature. Prototype inference model 204 may be provided (e.g., as part of prompts 200, prior to inferencing process 202) with additional contextual information regarding turning off the automatic emergency breaking feature, specific graphical user interfaces (GUIs), and/or other information to narrow a scope of responses 206 to an application relevant to the first owner (and/or the computer-implemented services provided by the first owner).

To evaluate agreement between responses of responses 206, response agreement testing process 208 may be performed. During response agreement testing process 208, responses 206 and a second LLM trained to compare information content of data structures provided as ingest (e.g., responses 206), such as existing inference model 210, may be used to obtain level of agreement 212. To do so, a response agreement testing prompt (not shown) may be provided to existing inference model 210.

The response agreement testing prompt may include: (i) responses 206, (ii) instructions for comparing information content of responses 206, and/or (iii) other information such as contextual information usable to compare responses 206. For example, the response agreement testing prompt may instruct existing inference model 210 to: (i) determine whether at least response 206A and response 206B seem to be responsive to a same prompt (e.g., question), (ii) determine whether response 206A and response 206B seem to have a same information content, and/or (iii) otherwise compare responses 206.

During response agreement testing process 208, an output may be obtained from existing inference model 210 in response to providing the agreement testing prompt to existing inference model 210. The output may include level of agreement 212 and/or may include information usable to obtain level of agreement 212. For example, the information usable to obtain level of agreement 212 may include: (i) a list of responses of responses 206 that existing inference model 210 considers as having a same information content, (ii) a list of prompts of prompts 200 that existing inference model 210 considers equivalent (e.g., via determining that responses to the prompts have a same information content), and/or (iii) other information. Therefore, during response agreement testing process 208, level of agreement 212 may be obtained (e.g., by reading the levels of agreement from the output, by analyzing and/or processing the output to obtain the levels of agreement).

Level of agreement 212 may indicate degrees of similarity between responses of responses 206 (e.g., between at least response 206A and response 206B). For example, level of agreement 212 may include: (i) a number of responses 206 that existing inference model 210 considers equivalent (e.g., shown as a number and/or as a percentage), (ii) a number of responses 206 that existing inference model 210 considers to be answers to a same prompt (e.g., shown as a number and/or as a percentage), and/or (iii) other quantifications of the degree of similarity.

In addition, the output from existing inference model 210 may be used to evaluate prompts 200 (not shown). By doing so, it may be determined whether prompts 200 may be modified. Prompts 200 may be modified, for example, if a first prompt from a first set of prompts (e.g., including solicitations for a first information content) is considered equivalent (e.g., by existing inference model 210) to a second prompt from a second set of prompts (e.g., including solicitations for a second information content) of prompts 200. The first prompt may be considered equivalent to the second prompt: (i) if existing inference model 210 determines that the first prompt and the second prompt seem to elicit same information content, (ii) if responses to the first prompt and the second prompt respectively seem to be responses to a same question, (iii) and/or based on other rules for prompt evaluation.

Turning to FIG. 2D, a fourth data flow diagram in accordance with an embodiment is shown. The fourth data flow diagram may illustrate data used in and data processing performed in performing, at least in part, a first testing procedure for prototype inference model 204. The first testing procedure may include performing a first attempting to verify that prototype inference model 204 provides consistent responses to a set of prompts based on the supplemental training data (e.g., supplemental training data 220 shown in FIGS. 2A and 2B).

To verify that prototype inference model 204 provides the consistent responses, comparison process 214 may be performed. During comparison process 214, it may be determined whether level of agreement 212 (e.g., described in FIG. 2B) meets criteria 216. Criteria 216 may be provided by a downstream consumer, a SME, and/or any other entity participating in management of inference models. Criteria 216 may include any number of thresholds, rule sets, and/or other means of determining whether degrees of similarity between responses 206 indicated by level of agreement 212 is considered acceptable.

For example, criteria 216 may include: (i) a threshold number and/or percentage of responses (e.g., 206) that existing inference model 210 considers equivalent, (ii) a threshold number of responses 206 that existing inference model 210 considers to be answers to a same prompt, and/or (iii) other thresholds.

If a quantity included in level of agreement 212 meets a corresponding threshold of criteria 216, it may be concluded that prototype inference model 204 provides the consistent responses to the set of prompts. If the quantity included in level of agreement 212 does not meet the corresponding threshold of criteria 216, it may be concluded that prototype inference model 204 does not provide the consistent responses to the set of prompts. For example, level of agreement 212 may indicate that 81% of responses 206 are considered to have a same information content and criteria 216 may include a threshold quantity of 75% of responses having the same information content. Therefore, in this example, level of agreement 212 may meet criteria 216.

While described above with respect to a single quantity and a single corresponding threshold, it may be appreciated that any number of quantities may be compared to any number of corresponding thresholds and/or any other types of rules may be applied to determine whether criteria 216 are met.

As a result of comparison process 214, result 218 may be obtained. Result 218 may include an indication of whether prototype inference model 204 provides the consistent responses. For example, result 218 may include a “yes” or “no” answer, may include any quantities of level of agreement 212, and/or may include other information.

If result 218 indicates prototype inference model 204 does not provide the consistent responses, a second partial training procedure for prototype inference model 204 may be performed to improve a likelihood that prototype inference model 204 provides the consistent responses. Refer to the description of FIG. 2A for additional details regarding performing the second partial training procedure.

If result 218 indicates prototype inference model 204 does provide the consistent responses, it may indicate that prototype inference model 204 is trained on the expanded knowledge base. A second attempting may then be performed to verify that existing inference model 210 provides inconsistent responses to the set of prompts. Refer to the description of FIG. 2E for additional details regarding the second attempting.

In addition, while described in FIGS. 2C-2D as obtaining level of agreement 212 from existing inference model 210 and performing comparison process 214 using level of agreement 212 and criteria 216, it may be appreciated that existing inference model 210 may also perform at least a portion of comparison process 214 and an output from existing inference model 210 may include a determination of whether prototype inference model 204 provides the consistent responses.

Following obtaining result 218 (and/or at other times such as prior to performing comparison process 214), additional testing processes may be performed to further interrogate responses of responses 206 that were determined to not be equivalent during agreement testing process 208. For example, a first response (e.g., response 206A) and a second response (e.g., response 206B) may be determined to not be equivalent by existing inference model 210. In response, existing inference model 210 may be prompted to explain a difference between response 206A and response 206B. Existing inference model 210 may generate a second output and the second output may include a description of the difference between response 206A and response 206B as determined by existing inference model 210. The second output may be evaluated (e.g., by an SME, by another entity, by a different inference model) to determine whether to retain or change a status of response 206A and response 206B being non-equivalent.

Thus, by implementing the data flows shown in FIGS. 2C-2D, a system in accordance with embodiments disclosed herein may be used in performing a first attempting as part of a first testing procedure to verify that prototype inference model 204 provides consistent responses to a set of prompts based on supplemental training data by comparing a level of agreement between responses generated by prototype inference model 204 to criteria. By performing at least a portion of the first attempting using a trusted second inference model (e.g., existing inference model 210), a resource cost (e.g., computational resources, time resources, cognitive resources) of evaluating prototype inference model 204 may be reduced.

Turning to FIG. 2E, a fifth data flow diagram in accordance with an embodiment is shown. The fifth data flow diagram may illustrate data used in and data processing performed in performing, at least in part, a first testing procedure for prototype inference model 204. The first testing procedure may include performing a second attempting to verify that existing inference model 210 provides inconsistent responses to a set of prompts based on (e.g., supplemental training data 220 shown in FIGS. 2A and 2B).

To perform the second attempting, response consistency testing process 226 may be performed. Response consistency testing process 226 may include processes similar to inferencing process 202, response agreement testing process 208, and/or comparison process 214 show in FIGS. 2C-2D. During response consistency testing process 226, a set of prompts (e.g., prompts 200) based on supplemental training data used to obtain prototype inference model 204 (not shown) and intended to elicit responses including information content of the supplemental training data may be provided to existing inference model 210. Prompts 200 may include the set of prompts used to evaluate the consistency of prototype inference model 204 during the performance of the first attempting.

To provide prompts 200 to existing inference model 210, prompts 200 may be fed to existing inference model 210 as ingest and a set of responses may be obtained as output (not shown). The set of responses may be used to perform a response agreement testing process (e.g., by existing inference model 210, by a third inference model) to obtain a level of agreement. The level of agreement may be compared to criteria (e.g., criteria 216) to determine whether the set of responses meets the criteria. If the level of agreement does not meet the criteria, it may be determined that existing inference model 210 provides the inconsistent responses. If the level of agreement meets the criteria, it may be determined that existing inference model 210 provides consistent responses. Refer to the description of FIGS. 2C-2D for additional details regrading obtaining the level of agreement based on the set of prompts and comparing the level of agreement to the criteria.

As a result of response consistency testing process 226, result 228 may be obtained. Result 228 may include an indication of whether existing inference model 210 provides the inconsistent responses. For example, result 228 may include a “yes” or “no” answer, may include any quantities of the level of agreement, and/or may include other information. Existing inference model 210 providing the inconsistent responses to prompts 200 may indicate that existing inference model 210 is not trained on the expanded knowledge base.

If result 228 indicates existing inference model 210 does not provide the inconsistent responses (e.g., existing inference model 210 provide consistent responses to the set of prompts based on the supplemental training), it may be concluded that prompts 200 is not usable to ascertain whether prototype inference model 204 has an expanded knowledge base compared to a knowledge base of existing inference model 210. As a result, prompts 200 may be modified (e.g., by the local resource, by a SME) to improve a likelihood that the set of prompts may be usable to ascertain whether prototype inference model 204 has the expanded knowledge base. Modifying the set of prompts may include: (i) removing at least one prompt from the set of prompts, (ii) adding at least one prompt to the set of prompts, (iii) updating at least one prompt from the set of prompts (e.g., by replacing words, adding and/or removing information content), and/or (v) other methods.

If result 228 indicates existing inference model 210 provides the inconsistent responses, a third attempting may be performed to verify that prototype inference model 204 provides accurate responses to the set of prompts. Refer to the description of FIG. 2F for additional details regarding performing the third attempting.

Turning to FIG. 2F, a sixth data flow diagram in accordance with an embodiment is shown. The sixth data flow diagram may illustrate data used in and data processing performed in performing, at least in part, a first testing procedure for prototype inference model 204. The first testing procedure may include performing a third attempting to verify that that prototype inference model 204 provides accurate responses to the set of prompts. The third attempting may be performed by comparing a set of responses (e.g., responses 206) from prototype inference model 204 to an information content of supplemental training data used to obtain prototype inference model 204 (e.g., supplemental training data 220). The third attempting may be performed to determine whether prototype inference model 204 has an expanded knowledge base when compared to a knowledge base of existing inference model 210. Prototype inference model 204 may have the expanded knowledge base if responses 206 is accurate (e.g., based on criteria 246).

While it may be determined that prototype inference model 204 provides consistent responses to a set of prompts (e.g., prompts 200) based on supplemental training data 220 (refer to FIGS. 2C-2D), it may not be concluded whether prototype inference model 204 has the expanded knowledge base. For example, prototype inference model 204 may provide consistent responses to prompts 200 which are inaccurate, incorrect, and/or otherwise erroneous.

Returning to the example where prototype inference model 204 is trained using training data regarding previous models of automobiles and supplemental training data regarding a new model of automobile, prototype inference model 204 may provide consistent responses to a set of prompts including a solicitation for a set of instructions for turning off an automatic emergency breaking feature. For example, the responses may include a same first information content indicating the automatic emergency breaking feature may be turned off by pushing a button on the steering wheel. While the responses may include a same first information content, the responses may be inaccurate. For example, the supplemental training data may include a second information content indicating the automatic emergency breaking feature may be turned off by depressing a pedal. Thus, prototype inference model 204 may provide responses to the set of prompts which are consistent, yet inaccurate. If the responses are inaccurate, it may be concluded that prototype inference model 204 does not have the expanded knowledge base.

To determine whether prototype inference model 204 has the expanded knowledge base, expanded knowledge base verification process 254 may be performed. During expanded knowledge base verification process 254, a first information content of responses 206 may be compared to a second information content of supplemental training data 220. Responses 206 may include a set of responses (e.g., 206A-206N) obtained during inferencing process 202 described in FIG. 2C and may be responsive to a set of prompts (e.g., prompts 200, not shown). The set of prompts may be intended to elicit responses including the second information content of supplemental training data 220. Thus, responses 206 may be considered accurate if the first information content of responses 206 is consistent with (e.g., considered sufficiently the same as) at least a portion of the second information content of supplemental training data 220 based on criteria 246.

Comparing the first information content of responses 206 to the second information content of supplemental training data 220 may include: (i) prompting existing inference model 210 (not shown) to compare the first information content and the second information content to obtain a level of similarity, (ii) providing the first information content and the second information content to a SME and or other entity for comparison, and/or (iii) other methods.

Existing inference model 210 may be prompted to compare the first information content and the second information content by feeding at least responses 206 and at least a portion of supplemental training data 220 into existing inference model 210. For example, a level of similarity prompt may be provided to existing inference model 210 (not shown) and the level of similarity prompt may instruct existing inference model 210 to determine whether responses 206 and supplemental training data 220 seem to have a same information content and/or otherwise compare responses 206 to supplemental training data 220.

During expanded knowledge base verification process 254, an output may be obtained from existing inference model 210 in response to providing the level of similarity prompt to existing inference model 210. The output may include a level of similarity between the first information content and the second information content (not shown) and/or may include information usable to obtain the level of similarity.

For example, the information usable to obtain the level of similarity may include a list of responses of responses 206 that existing inference model 210 considers as having a same information content as supplemental training data 220 and/or other information. The level of similarity may indicate an extent to which the first information content matches the second information content.

For example, the level of similarity may include: (i) a number of responses 206 that existing inference model 210 considers consistent (e.g., considers as having a same information content) with supplemental training data 220 (e.g., shown as a number and/or as a percentage), and/or (ii) other quantifications of the level of similarity.

During expanded knowledge base verification process 254, the level of similarity (not shown) may be compared criteria 246. Criteria 246 may include a level of similarity threshold.

The level of similarity threshold may be based on any criteria for accuracy of an inference model and may be obtained from: (i) a SME, (ii) a downstream consumer, (iii) another inference model, (iv) the first owner (e.g., of the local resource), and/or (v) from any other entity and/or source. If prototype inference model 204 meets the criteria for accuracy (e.g., criteria 246), it may be concluded that prototype inference model 204 provides accurate responses and thus, has the expanded knowledge base.

For example, the level of similarity may include a percentage indicating an extent to which the first information content (e.g., of responses 206) is considered consistent with the second information content (e.g., of supplemental training data 220). The level of similarity may, therefore, indicate that the first information content is 78% similar to the second information content. Criteria 246 may indicate that the first information content must be considered to be at least 85% similar to the second information content for prototype inference model 204 to be considered consistent with supplemental training data 220 and, therefore, provide accurate responses. Consequently, in this example, prototype inference model 204 may not provide the accurate responses.

As a result of expanded knowledge base verification process 254, result 256 may be obtained. Result 256 may include a “yes” or “no” designation regarding whether prototype inference model 204 provides the accurate responses to the set of prompts based on the comparison between the level of similarity and criteria 246.

If result 256 indicates that prototype inference model 204 provides the accurate responses, it may be concluded that prototype inference model 204 has the expanded knowledge base. Prototype inference model 204 may then be promoted to a production ready inference model (e.g., production ready inference model 244 shown in FIG. 2A) and used to provide computer-implemented services. Doing so may include replacing existing inference model 210 with prototype inference model 204 for at least a portion of providing the computer-implemented services. Replacing existing inference model 210 with prototype inference model 204 may include sending prompts to prototype inference model 204 rather than sending prompts to existing inference model 210 and using responses generated by prototype inference model 204 as part of providing the computer-implemented services.

If result 256 indicates that prototype inference model 204 does not provide the accurate responses, a second partial training procedure for prototype inference model 204 may be performed to improve a likelihood that prototype inference model 204 provides the accurate responses. Refer to the description of FIG. 2A for additional details regarding performing the second partial training procedure.

Thus, by implementing the data flow shown in FIG. 2F, a system in accordance with embodiments disclosed herein may be used to test whether a prototype inference model provides accurate responses to a set of prompts based on supplemental training data. By utilizing another inference model during the process of evaluating response accuracy (e.g., the existing inference model), resources may be conserved while determining whether the prototype inference model provides the accurate responses and thus, has the expanded knowledge base desired to provide computer-implemented services. Consequently, resources may be allocated to providing the computer-implemented services and a likelihood that the computer-implemented services may be provided as desired to downstream consumers may be increased.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2F may perform various methods to manage inference models. FIGS. 3A-3D illustrate a method that may be performed by the components of the system of FIGS. 1-2F. In the diagrams discussed below and shown in FIGS. 3A-3D, any of the operations may be repeated, performed in different orders, and/or performed in parallel with or in a partially overlapping in time manner with other operations.

Turning to FIG. 3A, a first flow diagram illustrating a method for providing computer-implemented services using inference models in accordance with an embodiment is shown. The method may be performed, for example, by any of the components of the system of FIG. 1, and/or any other entity without departing from embodiments disclosed herein.

At operation 300, supplemental training data may be obtained, the supplemental training data being usable to train a prototype inference model of the inference models, and the prototype inference model being based on an existing inference model of the inference models. Obtaining the supplemental training data may include: (i) reading the supplemental training data from storage (e.g., from a training data database), (ii) receiving the supplemental training data from another entity, (iii) generating the supplemental training data (e.g., to include an information content desired to be known by the prototype inference model), and/or (iv) other methods.

At operation 302, performance of a training procedure for the prototype inference model may be initiated using at least the supplemental training data and a set of prompts based on the supplemental training data until performance criteria are met, the performance criteria being usable to identify when the training procedure is complete and the performance criteria defining a level of ability of the prototype inference model to utilize an expanded knowledge base from the supplemental training data to generate desirable responses to the set of prompts. Initiating performance of the training procedure may include: (i) performing, using the supplemental training data, a first partial training procedure for the prototype inference model, (ii) performing a first testing procedure to determine whether the prototype inference model provides consistent and accurate responses to the set of prompts, (iii) in a first instance of the performing in which the prototype inference model provides the consistent and accurate responses: concluding that the prototype inference model meets the performance criteria, (iv) in a second instance of the performing in which the prototype inference model does not provide the consistent and accurate responses: performing a second partial training procedure for the prototype inference model, and/or (v) other methods. Refer to the description of FIG. 3B for additional details regarding performing the training procedure.

At operation 304, the prototype inference model may be promoted to a production ready inference model. Promoting the prototype inference model may include: (i) concluding the prototype inference model is sufficiently trained (e.g., identifying that the training procedure is complete, not continuing to perform additional partial training procedures for the prototype inference model), (ii) generating a data structure indicating that the prototype inference model has been promoted to the production ready inference model, (iii) storing the data structure in a database and/or other storage architecture for retrieval during providing the computer-implemented services, (iv) notifying (e.g., via a message over a communication system, via a graphical user interface (GUI) on a device) another entity (e.g., the remote resource, the local resource, a downstream consumer) that the prototype inference model has been promoted to the production ready inference model and, therefore, approved for use in providing the computer-implemented services, and/or (v) other methods.

At operation 306, the production ready inference model may be used to provide the computer-implemented services. Using the production ready inference model may include replacing the existing inference model with the production ready inference model in the provision of the computer-implemented services. Replacing the existing inference model may include: (i) modifying instructions for inference generation, the instructions including a list of inference models usable for generation of inferences during providing the computer-implemented services (e.g., removing the existing inference model from the list, adding the production ready inference model to the list, labeling the existing inference model in the list as being replaced by the production ready inference model), (ii) providing the instructions and/or another notification to any entity (e.g., the remote resource, a downstream consumer) indicating that the existing inference model is to be replaced by the production ready inference model, and/or (iii) other methods.

Providing the computer-implemented services using the production ready inference model may also include: (i) notifying (e.g., via a message over a communication system, via a graphical user interface (GUI) on a device) another entity (e.g., the remote resource, the local resource, a downstream consumer) that the production ready inference model is approved for use in providing the computer-implemented services, (ii) obtaining a new prompt for the production ready inference model, (iii) providing the new prompt to the production ready inference model (e.g., feeding the new prompt to the production ready inference model as ingest), (iv) receiving, in response to the new prompt, a new response generated by the production ready inference model, (v) providing at least a portion of the new response to a downstream consumer as part of providing the computer-implemented services, (v) using at least a portion of the new response to make decisions related to provisioning of the computer-implemented services, and/or (vi) other methods.

The method may end following operation 306.

Turning to FIG. 3B, a second flow diagram illustrating a method in accordance with an embodiment is shown. The second flow diagram may illustrate various operations performed while initiating performance of a training procedure for a prototype inference model based on an existing inference model using at least supplemental training data and a set of prompts based on the supplemental training data until performance criteria are met. The operations shown in FIG. 3B may be an expansion of operation 302 shown in FIG. 3A. The method may be performed, for example, by any of the components of the system of FIG. 1, and/or any other entity without departing from embodiments disclosed herein.

At operation 310, a first partial training procedure may be performed for the prototype inference model using the supplemental training data. Performing the first partial training procedure may include (i) obtaining a base set of training data used to train the existing inference model (e.g., reading the base set of training data from storage, receiving the base set of training data from another entity), (ii) obtaining the supplemental training data (refer to operation 300 in FIG. 3A), (iii) performing a first training for the prototype inference model using at least the base set of training data and the supplemental training data to provide responses based on a set of prompts, and/or (iv) other methods. Performing the first partial training may also include modifying the existing inference model using, at least in part, the supplemental training data to obtain the prototype inference model (e.g., retraining and/or partially retraining neurons and/or weights of the neural network of the existing inference model based on the supplemental training data).

Performing the first training for the prototype inference model may include: (i) using the base set of training data and the supplemental training data to define goals for responses generated by the prototype inference model, (ii) selecting parameters of the prototype inference model using an optimization process (e.g., an objective function may be defined in terms of the base set of training data, the supplemental training data, and responses generated by the prototype inference model, and a global optimization method such as gradient descent may be used to identify parameters that most faithfully reproduce the trends in the base set of training data and the supplemental training data), and/or (iii) other methods.

At operation 312, a first testing procedure may be performed to determine whether the prototype inference model provides consistent and accurate responses to the set of prompts. Performing the first testing procedure may include: (i) performing a first attempting to verify that the prototype inference model provides the consistent responses to the set of prompts, (ii) in a first instance of the first attempting where the prototype inference model provides the consistent responses: performing a second attempting to verify that the existing inference model provides inconsistent responses to the set of prompts, (iii) in a first instance of the second attempting where the existing inference model provides the inconsistent responses: performing, using the set of prompts, a third attempting to verify that the prototype inference model provides the accurate responses, and/or (iv) other methods. Refer to the description of FIG. 3C for additional details regarding performing the first testing procedure.

At operation 314, it may be determined whether the prototype inference model provides the consistent and accurate responses. Determining whether the prototype inference model provides the consistent and accurate responses may include reading a result of the first training procedure described in FIG. 3C.

If it is determined that the prototype inference model provides the consistent and accurate responses (e.g., the determination is “Yes” at operation 314), then the method may proceed to operation 316.

At operation 316, it may be concluded that the prototype inference model meets the performance criteria. Concluding that the prototype inference model meets the performance criteria may include: (i) concluding the prototype inference model is sufficiently trained (e.g., identifying that the training procedure is complete, not continuing to perform additional partial training procedures for the prototype inference model), (ii) generating a data structure indicating that the prototype inference model meets the performance criteria, (iii) storing the data structure in a database and/or other storage architecture for retrieval when providing the computer-implemented services using the prototype inference model, (iv) notifying (e.g., via a message over a communication system, via a graphical user interface (GUI) on a device) another entity (e.g., the remote resource, the local resource, a downstream consumer) that the prototype inference model meets the performance criteria, and/or (v) other methods.

The method may end following operation 316.

Returning to operation 314, if it is determined that the prototype inference model does not provide the consistent and accurate responses (e.g., the determination is “No” at operation 314), then the method may proceed to operation 318.

At operation 318, a second partial training procedure for the prototype inference model may be performed. Performing the second partial training procedure may include: (i) obtaining additional supplemental training data (reading the additional supplemental training data from storage, receiving the additional supplemental training data from another entity, generating the additional supplemental training data), (iii) performing a second training for the prototype inference model using at least the additional supplemental training data to obtain an updated prototype inference model, (iv) modifying the prototype inference model using, at least in part, the additional supplemental training data to obtain the updated prototype inference model (e.g., retraining and/or partially retraining neurons and/or weights of the neural network of the prototype inference model based on the additional supplemental training data), and/or (v) other methods.

Performing the second partial training procedure may also include performing a second testing procedure to determine whether the updated prototype inference model provides consistent and accurate responses to the set of prompts. Performing the second testing procedure may include methods similar to those described with respect to performing the first testing procedure in operation 312.

The method may end following operation 318.

Turning to FIG. 3C, a third flow diagram illustrating a method in accordance with an embodiment is shown. The third flow diagram may illustrate various operations performed while performing a first testing procedure to determine whether the prototype inference model based on an existing inference model provides consistent and accurate responses to a set of prompts. The operations shown in FIG. 3C may be an expansion of operation 312 shown in FIG. 3B. The method may be performed, for example, by any of the components of the system of FIG. 1, and/or any other entity without departing from embodiments disclosed herein.

At operation 320, a first attempting may be performed to verify that the prototype inference model provides the consistent responses to the set of prompts. Performing the first attempting may include: (i) obtaining a set of responses from the prototype inference model using the set of prompts, the set of responses including a first response to a first prompt of the set of prompts and a second response to a second prompt of the set of prompts, (ii) performing a response agreement testing process to obtain a level of agreement between at least the first response and the second response, (iii) making a determination regarding whether the level of agreement meets criteria, (iv) in a first instance of the determination in which the level of agreement meets the criteria: concluding that the prototype inference model provides the consistent responses to the set of prompts, (v) in a second instance of the determination in which the level of agreement does not meet the criteria: concluding that the prototype inference model does not provide the consistent responses to the set of prompts, and/or (vi) other methods. Refer to the description of FIG. 3D for additional details regarding performing the first attempting.

At operation 322, it may be determined whether the prototype inference model provides the consistent responses. Determining whether the prototype inference model provides the consistent responses may include reading a result of the first attempting described in FIG. 3D.

If it is determined that the prototype inference model provides the consistent responses (e.g., the determination is “Yes” at operation 322), then the method may proceed to operation 324.

At operation 324, a second attempting may be performed to verify that the existing inference model provides inconsistent responses to the set of prompts. Performing the second attempting may include: (i) providing the existing inference model the set of prompts as ingest, (ii) obtaining a set of responses to the set of prompts as output, the set of responses including a first response to a first prompt of the set of prompts and a second response to a second prompt of the set of prompts, (iii) performing a response agreement testing process to obtain a level of agreement between at least the first response and the second response, (iv) making a determination regarding whether the level of agreement meets criteria, and/or (v) other methods. Refer to the description of FIG. 3D for additional details regarding evaluating a consistency of responses provided by an inference model to a set of prompts.

At operation 326, it may be determined whether the existing inference model provides the inconsistent responses. Determining whether the existing inference model provides the inconsistent responses may include reading a result of the second attempting indicating whether the level of agreement meets the criteria. If the level of agreement does not meet the criteria, the existing inference model may provide the inconsistent responses and the method may proceed to operation 328 (e.g., the determination may be “Yes” at operation 326). If the level of agreement meets the criteria, the existing inference model may provide consistent responses and the method may proceed to operation 330 (e.g., the determination may be “No” at operation 326).

At operation 328, a third attempting may be performed using the set of prompts to verify that the prototype inference model provides the accurate responses. Performing the third attempting may include: (i) comparing a first information content of the consistent responses to a second information content of the supplemental training data to obtain a level of similarity between the first information content and the second information content, (ii) making a determination regarding whether the level of similarity meets a level of similarity threshold, and/or (iii) other methods.

Comparing the first information content of the consistent responses to the second information content of the supplemental training data may include: (i) prompting the existing inference model and/or a third inference model to compare the first information content and the second information content (e.g., providing the existing inference model a prompt, the prompt including instructions for the existing inference model to compare the first information content and the second information content), (ii) obtaining an output from the existing inference model, the output being usable to obtain a level of similarity, and/or (iii) other methods.

Making a determination regarding whether the level of similarity meets the level of similarity threshold may include: (i) obtaining the level of similarity threshold (e.g., reading the level of similarity threshold from storage, receiving the level of similarity threshold from another entity, generating the level of similarity threshold), (ii) comparing a quantity of the level of similarity to a corresponding threshold quantity of the level of similarity threshold, and/or (iii) other methods. Determining whether the level of similarity meets the level of similarity threshold may also include providing the level of similarity and the criteria to another entity responsible for comparing the level of similarity to the level of similarity threshold.

If the level of similarity meets the level of similarity threshold, it may be concluded that the prototype inference model provides the accurate responses. Concluding that the prototype inference model provides the accurate responses may include: (i) generating a data structure indicating that the prototype inference model provides the accurate responses, (ii) storing the data structure in a database and/or other storage architecture for retrieval when determining whether the prototype inference model meets performance criteria (refer to FIG. 3B), (iii) notifying (e.g., via a message over a communication system, via a graphical user interface (GUI) on a device) another entity (e.g., the remote resource, the local resource, a downstream consumer) that the prototype inference model provides the accurate responses, and/or (iv) other methods.

If the level of agreement does not meet the level of similarity threshold, it may be concluded that the prototype inference model does not provide the accurate responses. Concluding that the prototype inference model does not provide the accurate responses may include: (i) generating a data structure indicating that the prototype inference model does not provide the accurate responses, (ii) storing the data structure in a database and/or other storage architecture for retrieval when determining whether the prototype inference model meets performance criteria (refer to FIG. 3B), (iii) notifying (e.g., via a message over a communication system, via a graphical user interface (GUI) on a device) another entity (e.g., the remote resource, the local resource, a downstream consumer) that the prototype inference model does not provide the accurate responses, and/or (iv) other methods. If it is concluded that the prototype inference model does not provide the accurate responses, a second partial training procedure may be performed for the prototype inference model. Refer to the description of operation 318 in FIG. 3B for additional details regarding performing the second partial training procedure.

The method may end following operation 328.

Returning to operation 322, if it is determined that the prototype inference model does not provide the consistent responses (e.g., the determination is “No” at operation 322), then the method may proceed to operation 330.

At operation 330, a second partial training procedure for the prototype inference model may be performed. Refer to the description of operation 318 in FIG. 3B for additional details regarding performing the second partial training procedure.

The method may end following operation 330.

Returning to operation 326, the method may proceed to operation 330 if the existing inference model provides consistent responses to the set of prompts (e.g., the determination is “No” at operation 326). At operation 330, a second partial training procedure for the prototype inference model may be performed. Refer to the description of operation 318 in FIG. 3B for additional details regarding performing the second partial training procedure.

The method may end following operation 330.

Turning to FIG. 3D, a fourth flow diagram illustrating a method in accordance with an embodiment is shown. The fourth flow diagram may illustrate various operations performed while performing a first attempting to verify that a prototype inference model based on an existing inference model provides consistent responses to a set of prompts based on supplemental training data. The operations shown in FIG. 3D may be an expansion of operation 320 shown in FIG. 3C. The method may be performed, for example, by any of the components of the system of FIG. 1, and/or any other entity without departing from embodiments disclosed herein.

At operation 340, a set of responses may be obtained from the prototype inference model using a set of prompts, the set of responses including a first response to a first prompt of the set of prompts and a second response to a second prompt of the set of prompts. Obtaining the set of responses may include: (i) obtaining the set of prompts, (ii) feeding the set of prompts to the prototype inference model as ingest, (iii) receiving, in response to the set of prompts, the set of responses, and/or (iv) other methods. The set of prompts may be adapted to elicit responses from inference models including information content from the supplemental training data used to obtain the prototype inference model.

Obtaining the set of prompts may include: (i) reading the set of prompts from storage, (ii) receiving the set of prompts from another entity (e.g., via a transmission over a communication system), (iii) generating the set of prompts, and/or (iv) other methods.

Generating the set of prompts may include: (i) providing the supplemental training data to an inference model (e.g., the existing inference model, a third inference model), (ii) prompting the inference model to generate the set of prompts based on the supplemental training data which elicit responses including information content of the supplemental training data, (iii) obtaining an output from the inference model, the output including the set of prompts and/or being usable to obtain the set of prompts, and/or (iv) other methods.

At operation 342, a response agreement testing process may be performed to obtain a level of agreement using at least the first response and the second response. Performing the response agreement testing process may include: (i) prompting the existing inference model and/or a third inference model to compare an information content of at least the first response and the second response, (ii) obtaining an output from the existing inference model, the output being usable to obtain the level of agreement, and/or (iii) other methods.

Performing the response agreement testing process may also include obtaining the level of agreement. Obtaining the level of agreement may include: (i) parsing the output from the existing inference model to identify the level of agreement from the output, (ii) performing an analysis process and/or a data processing process using the output from the existing inference model to obtain the level of agreement, and/or (iii) other methods.

At operation 344, it may be determined whether the level of agreement meets criteria. Determining whether the level of agreement meets the criteria may include: (i) obtaining the criteria (e.g., reading the criteria from storage, receiving the criteria from another entity, generating the criteria), (ii) comparing a quantity of the level of agreement to a corresponding threshold quantity of the criteria, and/or (iii) other methods. Determining whether the level of agreement meets the criteria may also include providing the level of agreement and the criteria to another entity responsible for comparing the level of agreement to the criteria.

If it is determined that the level of agreement meets the criteria, the method may proceed to operation 346. At operation 346, it may be concluded that the prototype inference model provides the consistent responses to the set of prompts. Concluding that the prototype inference model provides the consistent responses to the set of prompts may include: (i) generating a data structure indicating that the prototype inference model provides the consistent responses to the set of prompts, (ii) storing the data structure in a database and/or other storage architecture, (iii) notifying (e.g., via a message over a communication system, via a graphical user interface (GUI) on a device) another entity (e.g., the remote resource, the local resource, a downstream consumer) that the prototype inference model provides the consistent responses to the set of prompts, and/or (iv) other methods.

The method may end following operation 346.

Returning to operation 344, the method may proceed to operation 348 if the level of agreement does not meet the criteria. At operation 348, it may be concluded that the prototype inference model does not provide the consistent responses to the set of prompts. Concluding that the prototype inference model does not provide the consistent responses to the set of prompts may include: (i) generating a data structure indicating that the prototype inference model does not provide the consistent responses to the set of prompts, (ii) storing the data structure in a database and/or other storage architecture, (iii) notifying (e.g., via a message over a communication system, via a GUI on a device) another entity (e.g., the remote resource, the local resource, a downstream consumer) that the prototype inference model does not provide the consistent responses to the set of prompts, and/or (iv) other methods.

The method may end following operation 348.

Thus, as illustrated above, embodiments disclosed herein may provide systems and methods usable to manage inference models so that a knowledge base of an inference model may be evaluated. The knowledge base of the inference model may be evaluated by evaluating an ability of the inference model to provide consistent and accurate responses to a set of prompts based on supplemental training data during training. By evaluating the inference model during training, an efficiency of training the inference model may be increased (e.g., via reduction of a resource cost) and a likelihood of providing the computer-implemented services as desired may be increased.

Any of the components illustrated in FIGS. 1-3D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using inference models, the method comprising:
obtaining supplemental training data, the supplemental training data being usable to train a prototype inference model of the inference models, and the prototype inference model being based on an existing inference model of the inference models;
initiating performance of a training procedure for the prototype inference model using at least the supplemental training data and a set of prompts based on the supplemental training data until performance criteria are met, the performance criteria being usable to identify when the training procedure is complete and the performance criteria defining a level of ability of the prototype inference model to utilize an expanded knowledge base from the supplemental training data to generate desirable responses to the set of prompts;
in a first instance of the initiating in which the performance criteria are met:
promoting the prototype inference model to a production ready inference model; and
using the production ready inference model to provide the computer-implemented services.

2. The method of claim 1, wherein initiating performance of the training procedure comprises:
performing, using the supplemental training data, a first partial training procedure for the prototype inference model;
performing a first testing procedure to determine whether the prototype inference model provides consistent and accurate responses to the set of prompts;
in a first instance of the performing in which the prototype inference model provides the consistent and accurate responses:
concluding that the prototype inference model meets the performance criteria; and
in a second instance of the performing in which the prototype inference model does not provide the consistent and accurate responses:
performing a second partial training procedure for the prototype inference model.

3. The method of claim 2, wherein performing the first testing procedure comprises:
performing a first attempting to verify that the prototype inference model provides the consistent responses to the set of prompts;
in a first instance of the first attempting where the prototype inference model provides the consistent responses:
performing a second attempting to verify that the existing inference model provides
inconsistent responses to the set of prompts; and
in a first instance of the second attempting where the existing inference model provides the inconsistent responses:
performing, using the set of prompts, a third attempting to verify that the prototype inference model provides the accurate responses.

4. The method of claim 3, wherein performing the first attempting comprises:
obtaining, using the set of prompts, a set of responses from the prototype inference model, the set of responses comprising:
a first response to a first prompt of the set of prompts; and
a second response to a second prompt of the set of prompts;
performing a response agreement testing process to obtain a level of agreement between at least the first response and the second response;
making a determination regarding whether the level of agreement meets criteria;
in a first instance of the determination in which the level of agreement meets the criteria:
concluding that the prototype inference model provides the consistent responses to the set of prompts; and
in a second instance of the determination in which the level of agreement does not meet the criteria:
concluding that the prototype inference model does not provide the consistent responses to the set of prompts.

5. The method of claim 4, wherein performing the third attempting comprises:
comparing a first information content of the consistent responses to a second information content of the supplemental training data to obtain a level of similarity between the first information content and the second information content;
making a second determination regarding whether the level of similarity meets a level of similarity threshold;
in a first instance of the second determination in which the level of similarity meets the level of similarity threshold:
concluding that the prototype inference model provides the accurate responses; and
in a second instance of the second determination in which the level of similarity does not meet the level of similarity threshold:
concluding that the prototype inference model does not provide the accurate responses.

6. The method of claim 1, wherein the prototype inference model is intended to have the expanded knowledge base when compared to a knowledge base of the existing inference model.

7. The method of claim 6, wherein providing consistent and accurate responses to the set of prompts indicates that the prototype inference model has the expanded knowledge base.

8. The method of claim 1, wherein the set of prompts is adapted to elicit responses from inference models comprising information content from the supplemental training data.

9. The method of claim 8, wherein the existing inference model is based on a base set of training data that excludes the supplemental training data, and the information content from the supplemental training data is not part of the base set of training data.

10. The method of claim 1, wherein the prototype inference model and the existing inference model are known to provide consistent responses to a second set of prompts, the second set of prompts being based on a knowledge base of the existing inference model.

11. The method of claim 1, wherein the existing inference model and the prototype inference model are generative artificial intelligence (AI) models.

12. A non-transitory machine-readable medium having instructions stored therein, which when executed by a processor, cause the processor to perform operations for providing computer-implemented services using inference models, the operations comprising:
obtaining supplemental training data, the supplemental training data being usable to train a prototype inference model of the inference models, and the prototype inference model being based on an existing inference model of the inference models;
initiating performance of a training procedure for the prototype inference model using at least the supplemental training data and a set of prompts based on the supplemental training data until performance criteria are met, the performance criteria being usable to identify when the training procedure is complete and the performance criteria defining a level of ability of the prototype inference model to utilize an expanded knowledge base from the supplemental training data to generate desirable responses to the set of prompts;
in a first instance of the initiating in which the performance criteria are met:
promoting the prototype inference model to a production ready inference model; and
using the production ready inference model to provide the computer-implemented services.

13. The non-transitory machine-readable medium of claim 12, wherein initiating performance of the training procedure comprises:
performing, using the supplemental training data, a first partial training procedure for the prototype inference model;
performing a first testing procedure to determine whether the prototype inference model provides consistent and accurate responses to the set of prompts;
in a first instance of the performing in which the prototype inference model provides the consistent and accurate responses:
concluding that the prototype inference model meets the performance criteria; and
in a second instance of the performing in which the prototype inference model does not provide the consistent and accurate responses:
performing a second partial training procedure for the prototype inference model.

14. The non-transitory machine-readable medium of claim 13, wherein performing the first testing procedure comprises:
performing a first attempting to verify that the prototype inference model provides the consistent responses to the set of prompts;
in a first instance of the first attempting where the prototype inference model provides the consistent responses:
performing a second attempting to verify that the existing inference model provides inconsistent responses to the set of prompts; and
in a first instance of the second attempting where the existing inference model provides the inconsistent responses:
performing, using the set of prompts, a third attempting to verify that the prototype inference model provides the accurate responses.

15. The non-transitory machine-readable medium of claim 14, wherein performing the first attempting comprises:
obtaining, using the set of prompts, a set of responses from the prototype inference model, the set of responses comprising:
a first response to a first prompt of the set of prompts; and
a second response to a second prompt of the set of prompts;
performing a response agreement testing process to obtain a level of agreement between at
least the first response and the second response;
making a determination regarding whether the level of agreement meets criteria;
in a first instance of the determination in which the level of agreement meets the criteria:
concluding that the prototype inference model provides the consistent responses to the set of prompts; and
in a second instance of the determination in which the level of agreement does not meet the criteria:
concluding that the prototype inference model does not provide the consistent responses to the set of prompts.

16. The non-transitory machine-readable medium of claim 15, wherein performing the third attempting comprises:
comparing a first information content of the consistent responses to a second information content of the supplemental training data to obtain a level of similarity between the first information content and the second information content;
making a determination regarding whether the level of similarity meets a level of similarity threshold;
in a first instance of the determination in which the level of similarity meets the level of similarity threshold:
concluding that the prototype inference model provides the accurate responses; and
in a second instance of the determination in which the level of similarity does not meet the level of similarity threshold:
concluding that the prototype inference model does not provide the accurate responses.

17. A data processing system, comprising:
a processor; and
a memory coupled to the processor to store instructions, which when executed by the processor, cause the processor to perform operations for providing computer-implemented services using inference models, the operations comprising:
obtaining supplemental training data, the supplemental training data being usable to train a prototype inference model of the inference models, and the prototype inference model being based on an existing inference model of the inference models;
initiating performance of a training procedure for the prototype inference model using at least the supplemental training data and a set of prompts based on the supplemental training data until performance criteria are met, the performance criteria being usable to identify when the training procedure is complete and the performance criteria defining a level of ability of the prototype inference model to utilize an expanded knowledge base from the supplemental training data to generate desirable responses to the set of prompts;
in a first instance of the initiating in which the performance criteria are met:
promoting the prototype inference model to a production ready inference model; and
using the production ready inference model to provide the computer-implemented services.

18. The data processing system of claim 17, wherein initiating performance of the training procedure comprises:
performing, using the supplemental training data, a first partial training procedure for the prototype inference model;
performing a first testing procedure to determine whether the prototype inference model provides consistent and accurate responses to the set of prompts;
in a first instance of the performing in which the prototype inference model provides the consistent and accurate responses:
concluding that the prototype inference model meets the performance criteria; and
in a second instance of the performing in which the prototype inference model does not provide the consistent and accurate responses:
performing a second partial training procedure for the prototype inference model.

19. The data processing system of claim 18, wherein performing the first testing procedure comprises:
performing a first attempting to verify that the prototype inference model provides the consistent responses to the set of prompts;
in a first instance of the first attempting where the prototype inference model provides the consistent responses:
performing a second attempting to verify that the existing inference model provides inconsistent responses to the set of prompts; and
in a first instance of the second attempting where the existing inference model provides the inconsistent responses:
performing, using the set of prompts, a third attempting to verify that the prototype inference model provides the accurate responses.

20. The data processing system of claim 19, wherein performing the first attempting comprises:
obtaining, using the set of prompts, a set of responses from the prototype inference model, the set of responses comprising:
a first response to a first prompt of the set of prompts; and
a second response to a second prompt of the set of prompts;
performing a response agreement testing process to obtain a level of agreement between at least the first response and the second response;
making a determination regarding whether the level of agreement meets criteria;
in a first instance of the determination in which the level of agreement meets the criteria:
concluding that the prototype inference model provides the consistent responses to the set of prompts; and
in a second instance of the determination in which the level of agreement does not meet the criteria:
concluding that the prototype inference model does not provide the consistent responses to the set of prompts.
